(19) United States
(12) Patent Application Publication
(10) Pub. No.: US 2006/0209872 A1
(43) Pub. Date: Sep. 21, 2006

(54) IP telephone apparatus and IP adapter apparatus

(75) Inventor: Kuniaki Matsui, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/344,222

(22) Filed: Feb. 1, 2006

(30) Foreign Application Priority Data
Feb. 2, 2005 (JP) 2005-026646

(51) Int. Cl. H04J 3/16

(52) U.S. Cl. 370/437

(57) ABSTRACT

An IP telephone apparatus is provided. Before a status that transmission data can be transmitted to/received from the counter party of communication is established, a communication status measuring unit measures the communication status with the counter party of communication. A transmission rate setting unit sets a transmission rate of transmission data from a communication interface to a transmission rate corresponding to the measurement result from the communication status measuring unit on the basis of the measurement result. During a transmission time when the status that transmission data can be transmitted to/received from the counter party of communication is established, the measurement of the communication status by the communication status measuring unit and the setting of the transmission rate by the transmission rate setting unit, similarly to those before the status that transmission data can be transmitted to/received from the counter party of communication is established.

### BACKGROUND OF THE INVENTION

1. Field of the Invention

The present invention relates to an Internet Protocol (IP) telephone apparatus and an IP adapter apparatus for transmitting/receiving at least one of voice data and image data as transmission data to/from a counter party of communication by the use of Internet.

2. Description of the Related Art

An IP telephone apparatus such as IP phone and IP television phone transmits/receives such transmission data as voice data and image data to/from a counter party of communication by the use of Internet. The IP telephone apparatus transmits and receives the transmission data in the communication form based on a protocol for transmitting and receiving transmission data in real time, for example, RTP (Real-time Transport Protocol) or the like. When a lot of errors occur in communication, the IP telephone apparatus ends the status that transmission data can be transmitted to and received from the counter party of communication.

In the IP telephone apparatus, the transmission rate of transmission data is set to one of a plurality of selectable transmission rates, before the status that transmission data can be transmitted to and received from the counter party of communication is established. The transmission data are transmitted and received at the set transmission rate. In such an IP telephone apparatus, when a service with a specific communication capacity is being provided from an ISP (Internet Services Provider), the transmission data are transmitted and received at a transmission rate supported by the service.

An IP adapter apparatus is interposed between a telephone apparatus for a public switched telephone network and Internet. The IP adapter apparatus transmits and receives the transmission data by the use of Internet, similarly to the IP telephone apparatus described above.

Japanese Unexamined Patent Publication JP-A 2000-224172 discloses a technology of estimating an available bandwidth of a network channel by the use of a measuring packet.

Japanese Unexamined Patent Publication JP-A 2004-32668 discloses a technology of estimating quality of service (QoS) of a network.

Japanese Unexamined Patent Publications JP-A 2003-244213 and JP-A 2001-197126 disclose a technology relating to tunneling. The tunneling is a technology of performing a packet communication between hosts included in different networks through a base network under the condition that a plurality of different networks based on protocols different from that of the base network coexist in the base network.

In JP-A 2003-244213, in order to efficiently perform a packet communication through the optimal tunnel path, communication qualities of a plurality of predetermined candidate tunnel paths are measured and one tunnel path is set on the basis of the measured communication quality.

In JP-A 2001-197126, in order to efficiently perform a communication even when a plurality of IP tunnels are used as a plurality of tunnel paths having different available transmission bandwidths, an available transmission band between inter-network connectors opposed to each other with the respective IP tunnels therebetween is measured and the amount of packets to be transmitted to the corresponding network connector is distributed to the respective IP channels in accordance with the measurement result of bandwidth.

Japanese Unexamined Patent Publication JP-A 4-139987 (1992) discloses a technology relating to a television phone having a communication speed switching function. In the television phone, by pressing a communication speed setting key disposed in a manipulation unit during transmission of images, the communication speed is switched.

When transmission data are transmitted and received by the use of Internet, the communication status with the counter party of communication varies depending upon communication paths and varies depending upon times. For example, time delay and packet loss occur due to a jam of traffic and noises. When the assurance of bandwidth is not complete, the actual communication capacity is decreased due to the jam of traffic even when a service with a specific communication capacity is provided from an ISP.

In spite of this status, the IP telephone apparatus sets the transmission rate of transmission data without considering the communication status with the counter party of communication at all. In other words, the IP telephone apparatus transmits and receives the transmission data at a predetermined transmission rate, whether the communication status is good or bad.

Such an IP telephone apparatus has a problem in that when the communication status is not good due to the jam of traffic, errors often occur in communication, thereby ending during communication the status that the transmission data can be transmitted and received between the IP telephone apparatus and the counter party of communication. In addition, the IP telephone apparatus has a problem in that even when the communication status with the counter party of communication is very good, the transmission data cannot help being transmitted and received at a predetermined transmission rate, thereby not enhancing sound quality and image quality.

In order to solve the above-mentioned problems, an operator can be allowed to select the transmission rate of transmission data in consideration of the communication status with the counter party of communication before the status that the transmission data may be transmitted and received between the IP telephone apparatus and the counter party of communication is established. However, in this case, there occurs a problem in that a burden of the operator is increased. Further, the operator may be allowed to change the transmission rate of transmission data during communication in consideration of change in communication status with the counter party of communication. In this case, there occurs a problem in that the burden of the operator is increased.

Similarly to the IP telephone apparatus, since the IP adapter apparatus transmits and receives transmission data by the use of Internet, the IP adapter apparatus also has the same problems as the IP telephone apparatus.

The technology disclosed in JP-A 2000-224172 is a technology of estimating an available bandwidth of a network path. The above-mentioned problems cannot be solved by the use of only this technology.

The technology disclosed in JP-A 2004-32668 is a technology of estimating the quality of service (QoS) of a network. The above-mentioned problems cannot be solved by the use of only this technology.

The technology disclosed in JP-A 2003-244213 is a technology of selecting the optimal tunnel path from a plurality of tunnel paths, but is not such a technology to optimize the transmission rate in accordance with the communication status. Accordingly, the above-mentioned problems cannot be solved by the use of this technology.

The technology disclosed in JP-A 2001-197126 is a technology of distributing the amount of packets to be transmitted to the corresponding network connector into the respective IP tunnels, but is not such a technology to optimize the transmission rate in accordance with the communication status. Accordingly, the above-mentioned problems cannot be solved by the use of this technology.

The technology disclosed in JP-A 4-139987 (1992) is not a technology using Internet and is not such a technology to optimize the transmission rate in accordance with the communication status. Accordingly, the above-mentioned problems cannot be solved by the use of this technology.

### SUMMARY OF THE INVENTION

An object of the invention is to provide an IP telephone apparatus and an IP adapter apparatus which can transmit and receive transmission data at a transmission rate corresponding to a communication status with a counter party of communication without imposing any burden on an operator.

According to an aspect of the invention, there is provided an IP telephone apparatus for transmitting/receiving at least one of voice data and image data to/from a counter party of communication by the use of Internet, the IP telephone apparatus comprising: communication means for transmitting and receiving transmission data; communication status measuring means for measuring a communication status with the counter party of communication; and transmission rate setting means for setting a transmission rate of transmission data from the communication means to a transmission rate corresponding to the measurement result on the basis of the measurement result from the communication status measuring means.

According to this configuration, the communication means transmits/receives at least one of voice data and image data to/from the counter party of communication by the use of Internet. The communication status measuring means measures the communication status with the counter party of communication. The transmission rate setting means sets the transmission rate of transmission data from the communication means to a transmission rate corresponding to the measurement result on the basis of the measurement result from the communication status measuring means. In this way, since the transmission rate is set, it is possible to transmit and receive transmission data at the transmission rate corresponding to the communication status with the counter party of communication without giving an operator a burden for setting the transmission rate.

When the communication status is not good, an error can be reduced in communication by transmitting and receiving transmission data at a low transmission rate corresponding to the communication status. When the communication status is good, it is possible to enhance the sound quality and the image quality by transmitting and receiving transmission data at a high transmission rate corresponding to the communication status.

In the invention, it is preferable that before a status that transmission data can be transmitted to and received from the counter party of communication is established, the communication status measuring means measures the communication status with the counter party of communication and the transmission rate setting means sets the transmission rate of transmission data from the communication means to a transmission rate corresponding to the measurement result on the basis of the measurement result from the communication status measuring means.

According to this configuration, before the status that transmission data can be transmitted to and received from the counter party of communication is established, the measurement of the communication status by the communication status measuring means and the setting of the transmission rate by the transmission rate setting means are performed as described above. Accordingly, since the status that transmission data can be transmitted to and received from the counter party of communication is established, it is possible to transmit and receive transmission data at the transmission rate corresponding to the communication status with the counter party of communication, from the time when the transmission and reception of the transmission data is started.

In the invention, it is preferable that during a transmission time when the status that transmission data can be transmitted to and received from the counter party of communication is established, the communication status measuring means measures the communication status with the counter party of communication and the transmission rate setting means sets the transmission rate of transmission data from the communication means to a transmission rate corresponding to the measurement result on the basis of the measurement result from the communication status measuring means.

According to this configuration, during the transmission time when the status that transmission data can be transmitted to and received from the counter party of communication is established, the measurement of the communication status by the communication status measuring means and the setting of the transmission rate by the transmission rate setting means are performed as described above. Accordingly, during the transmission time, it is possible to transmit and receive transmission data at the transmission rate corresponding to the communication status with the counter party of communication.

In the invention, it is preferable that every predetermined time interval in the transmission time, the communication status measuring means measures the communication status with the counter party of communication and the transmission rate setting means sets the transmission rate of transmission data from the communication means to a transmission rate corresponding to the measurement result on the basis of the measurement result from the communication status measuring means.

According to this configuration, every predetermined time interval in the transmission time, the measurement of the communication status by the communication status measuring means and the setting of the transmission rate by the transmission rate setting means are performed as described above. Accordingly, even when the communication status with the counter party of communication varies during the transmission time, it is possible to transmit and receive transmission data at the transmission rate corresponding to the communication status with the counter party of communication every predetermined time interval.

In the invention, it is preferable that the predetermined time is set in accordance with the measurement result from the communication status measuring means.

According to this configuration, the predetermined time is set in accordance with the measurement result from the communication status measuring means. When the communication status is good, the time until the communication status becomes worse is relatively long as the change of the transmission rate is necessary more and more. By elongating the predetermined time in consideration of this fact, it is possible to reduce the amount of process necessary for measuring the communication status and setting the transmission rate. When the communication status is not good, the time until the communication status becomes worse is relatively short as the change of the transmission rate is necessary more and more. By shortening the predetermined time in consideration of this fact, it is possible to shorten the time when the transmission rate of transmission data does not correspond to the communication status.

In the invention, it is preferable that the IP telephone apparatus further comprises input means for inputting a transmission rate setting command instructing to set the transmission rate of transmission data, and when the transmission rate setting command is inputted by the input means during the transmission and reception, the communication status measuring means measures the communication status with the counter party of communication and the transmission rate setting means sets the transmission rate of transmission data from the communication means to a transmission rate corresponding to the measurement result on the basis of the measurement result from the communication status measuring means.

According to this configuration, when the transmission rate setting command is inputted by the input means during the transmission of the transmission data, the measurement of the communication status by the communication status measuring means and the setting of the transmission rate by the transmission rate setting means are performed. Accordingly, the operator can be instructed to measure the communication status and to set the transmission rate, thereby improving usability.

In the invention, it is preferable that when the transmission rate of transmission data from the communication means is set in advance, the transmission rate setting means compares the set transmission rate with the transmission rate corresponding to the measurement result, maintains the transmission rate of transmission data from the communication means at the set transmission rate when the transmission rates are equal to each other, and sets the transmission rate of transmission data from the communication means to the transmission rate corresponding to the measurement result when the transmission rates are different from each other.

According to this configuration, when the transmission rate of transmission data from the communication means is set in advance, the set transmission rate is compared with the transmission rate corresponding to the measurement result. When the transmission rates are different from each other, the transmission rate of transmission data from the communication means is set to the transmission rate corresponding to the measurement result and when the transmission rates are equal to each other, the transmission rate of transmission data is maintained at the set transmission rate. Accordingly, the amount of process necessary for setting the transmission rate can be reduced.

In the invention, it is preferable that the communication status measuring means measures at least one of a communication capacity, a time delay, a packet loss ratio, and a jitter as the communication status.

According to this configuration, by measuring at least one of a communication capacity, a time delay, a packet loss ratio, and a jitter as the communication status, it is possible to accurately recognize the communication status.

In the invention, it is preferable that the IP telephone apparatus further comprises a database in which relation information indicating a relation between the communication status and a reference transmission rate corresponding to the communication status is stored in advance, and the transmission rate setting means sets the transmission rate of transmission data from the communication means to the transmission rate corresponding to the measurement result on the basis of the measurement result from the communication status measuring means and the relation information recorded in the database.

According to this configuration, the relation information indicating the relation between the communication status and the reference transmission rate corresponding to the communication status is stored in advance in the database. The transmission rate setting means sets the transmission rate of transmission data from the communication means to the transmission rate corresponding to the measurement result on the basis of the measurement result from the communication status measuring means and the relation information stored in the database. In this way, since the relation information stored in the database is used, it is possible to easily set the transmission rate in comparison with the case that a relational expression between the communication status and the reference transmission rate corresponding to the communication status is used.

In the invention, it is preferable that on the basis of a plurality of transmission rates selectable by the IP telephone apparatus, a plurality of transmission rates selectable by the counter party of communication, and the measurement result from the communication status measuring means, the transmission rate setting means sets the transmission rate of transmission data from the communication means to the transmission rate corresponding to the measurement result among the transmission rates common to the plurality of transmission rates selectable by the IP telephone apparatus and the plurality of transmission rates selectable by the counter party of communication.

According to this configuration, the transmission rate setting means sets the transmission rate of transmission data from the communication means to the transmission rate corresponding to the measurement result among the transmission rates common to the plurality of transmission rates selectable by the IP telephone apparatus and the plurality of transmission rates selectable by the counter party of communication. Accordingly, after a problem of compatibility of a transmission rate with the counter party of communication is solved, that is, in the status where the transmission rate is made to be equal to that of the counter party of communication, it is possible to transmit and receive transmission data.

According to another aspect of the invention, there is provided an IP adapter apparatus which is interposed between a telephone apparatus for a public switched telephone network and Internet and which transmits/receives at least one of voice data and image data to/from a counter party of communication by the use of Internet in a status that a transmission rate is made to be equal to that of the counter party of communication, the IP adapter apparatus comprising: communication means for transmitting and receiving transmission data; communication status measuring means for measuring a communication status with the counter party of communication; and transmission rate setting means for setting a transmission rate of transmission data from the communication means to a transmission rate corresponding to the measurement result on the basis of the measurement result from the communication status measuring means.

According to this configuration, the IP adapter apparatus is interposed between a telephone apparatus for a public switched telephone network and Internet. The communication means transmits/receives at least one of voice data and image data to/from the counter party of communication by the use of Internet. The communication status measuring means measures the communication status with the counter party of communication. The transmission rate setting means sets the transmission rate of transmission data from the communication means to a transmission rate corresponding to the measurement result on the basis of the measurement result from the communication status measuring means. In this way, since the transmission rate is set, it is possible to transmit and receive transmission data at the transmission rate corresponding to the communication status with the counter party of communication without giving an operator a burden for setting the transmission rate, even when the telephone apparatus for a public switched telephone network is used.

When the communication status is not good, an error can be reduced in communication by transmitting and receiving transmission data at a low transmission rate corresponding to the communication status. When the communication status is good, it is possible to enhance the sound quality and the image quality by transmitting and receiving transmission data at a high transmission rate corresponding to the communication status.

### BRIEF DESCRIPTION OF THE DRAWINGS

Other and further objects, features, and advantages of the invention will be more explicit from the following detailed description taken with reference to the drawings wherein:

FIG. 1 is a functional block diagram illustrating an IP television phone according to an embodiment of the invention;

FIG. 2 is a front view simply illustrating the IP television phone;

FIG. 3 is a diagram illustrating an example of a communication path between the IPTV phone and the counter party of communication;

FIG. 4 is a diagram illustrating an example of relation information stored in advance in the communication quality database;

FIG. 5 is a flowchart illustrating a communication control operation performed by the control unit of the IPTV phone;

FIG. 6 is a sequence diagram illustrating a flow until a session is established between the IPTV phone and the counter party of communication;

FIG. 7 is a sequence diagram illustrating a flow of resetting the transmission rate of transmission data during the session;

FIG. 8 is a flowchart illustrating a communication control operation of the control unit included in an IPTV phone according to another embodiment of the invention;

FIG. 9 is a flowchart illustrating a communication control operation of the control unit included in an IPTV phone according to another embodiment of the invention; and

FIG. 10 is a diagram illustrating an example of a communication path between an IP adapter apparatus and a counter party of communication according to another embodiment of the invention.

### DETAILED DESCRIPTION

Now referring to the drawings, preferred embodiments of the invention are described below.

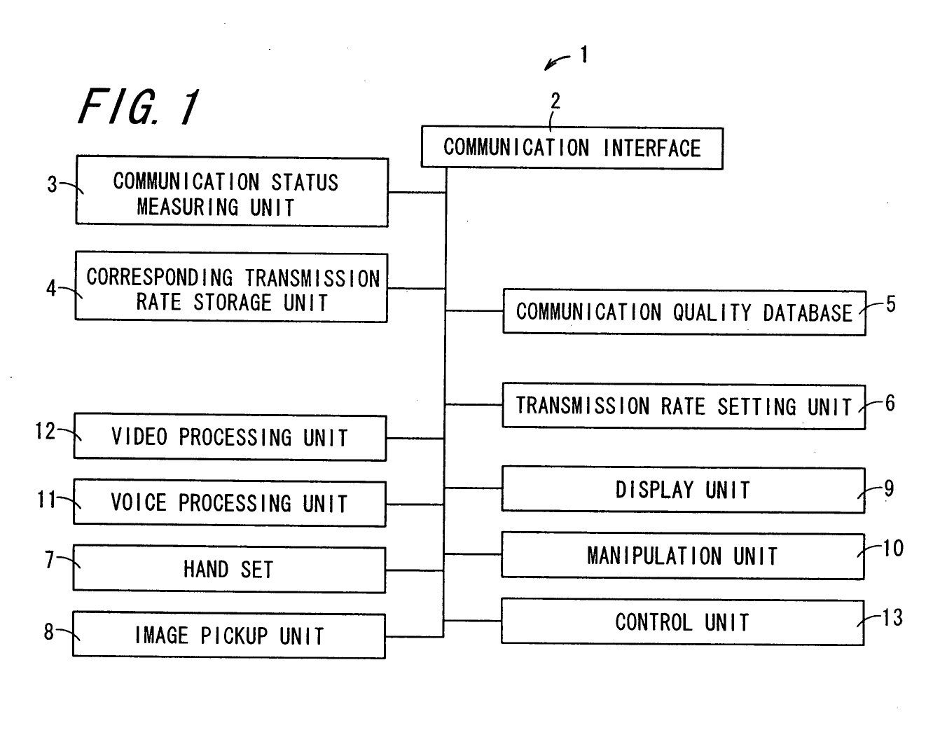

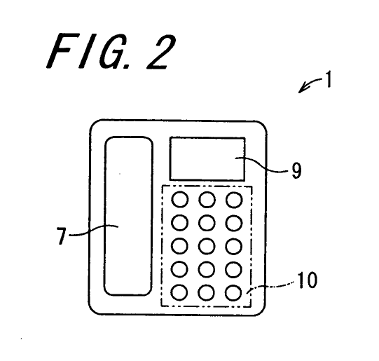

FIG. 1 is a functional block diagram illustrating an IP television phone 1 according to an embodiment of the invention. FIG. 2 is a front view simply illustrating the IP television phone 1. The IP television phone 1 (hereinafter, referred to as IPTV phone) as an IP telephone apparatus transmits/receives transmission data including voice data and image data to/from a counter party of communication by the use of Internet. The IPTV phone 1 performs a streaming process of reproducing the transmission data at the same time as receiving the transmission data.

The counter party of communication is a communication apparatus for transmitting transmission data to the IPTV phone 1 according to this embodiment and receiving transmission data from the IPTV phone 1 according to this embodiment by the use of Internet. In the embodiment, the counter party of communication is an IPTV phone.

The IPTV phone 1 has a plurality of transmission modes and the transmission modes have different transmission rates of the transmission data, respectively. The IPTV phone 1 can select a transmission mode and thus can select the transmission rates of transmission data. The counter party of communication has a plurality of transmission modes and the transmission modes have different transmission rates of the transmission data, respectively. The counter party of communication can select a transmission mode and thus can select the transmission rates of transmission data. A plurality of transmission rates selectable by the IPTV phone 1 and a plurality of transmission rates selectable by the counter party of communication are partially or all equal to each other.

In the embodiment, it is assumed that one SIP (Session Initiation Protocol) of a VoIP (Voice over Internet Protocol) is used. The IPTV phone 1 and the counter party of communication transmits and receives the transmission data in the communication form based on a protocol for transmitting and receiving voice data, etc. in real time, for example, an RTP (Real-time Transport Protocol).

The IPTV phone 1 includes a communication interface 2 as communication means, a communication status measuring unit 3 as communication status measuring means, a corresponding transmission rate storage unit 4, a communication quality database 5, a transmission rate setting unit 6 as transmission rate setting means, a hand set 7, an image pickup unit 8, a display unit 9, a manipulation unit 10, a voice processing unit 11, a video processing unit 12, and a control unit 13.

The communication interface 2 transmits and receives transmission data. The communication status measuring unit 3 measures a communication status with a counter party of communication. The communication status measuring unit 3 measures a first communication status relating to a data transmission rate and a second communication status relating to an error in communication as the communication status. Specifically, the communication status measuring unit 3 measures a communication capacity as the first communication status and measures a delay and a packet loss ratio as the second communication status.

The communication capacity is the maximum data transmission rate executable between the IPTV phone 1 and the counter party of communication. The delay is a time necessary for transmitting data from the IPTV phone 1 to the counter party of communication. The packet loss ratio is a ratio of packets not arriving at the counter party of communication among the packets transmitted from the IPTV phone 1.

The corresponding transmission rate storage unit 4 stores in advance information on a plurality of transmission rates which can be selected by the IPTV phone. The corresponding transmission rate storage unit 4 stores information on a plurality of transmission rates selectable by the counter party of communication. The information on a plurality of transmission rates selectable by the counter party of communication is supplied from the counter party of communication.

The communication quality database 5 is an apparatus in which relation information indicating a relation between a communication status and a reference transmission rate corresponding to the communication status is stored in advance. The transmission rate setting unit 6 sets the transmission rate of transmission data from the communication interface 2 to a transmission rate corresponding to the measurement result, on the basis of the measurement result from the communication status measuring unit 3, the relation information stored in the communication quality database 5, and the information stored in the corresponding transmission rate storage unit 4.

The hand set 7 includes a microphone for converting surrounding voices into voice data and a speaker for converting voice data from the counter party of communication into voices. The image pickup unit 8 picks up the surroundings and generates image data. The display unit 9 displays images corresponding to the image data from the counter party of communication. The manipulation unit 10 has manipulation keys which can be manipulated by an operator and supplies the control unit 13 with information input by means of manipulation of the manipulation keys.

The voice processing unit 11 encodes the voice data from the microphone of the hand set 7 and supplies the encoded voice data to the communication interface 2. The voice processing unit 11 decodes the voice data from the communication interface 2 and supplies the decoded voice data to the speaker of the hand set 7. The video processing unit 12 encodes the image data from the image pickup unit 8 and supplies the encoded image data to the communication interface 2. The video processing unit 12 decodes the image data from the communication interface 2 and supplies the decoded image data to the display unit 9.

The control unit 13 is means for controlling the communication interface 2, the communication status measuring unit 3, the corresponding transmission rate storage unit 4, the communication quality database 5, the transmission rate setting unit 6, the hand set 7, the image pickup unit 8, the display unit 9, the manipulation unit 10, the voice processing unit 11, and the video processing unit 12, and is embodied by, for example, a central processing unit (CPU).

The control unit 13 controls the communication status measuring unit 3 to measure the communication status with the counter party of communication, before the status that transmission data can be transmitted and received between the IPTV phone and the counter party of communication is established, that is, before a session is established. The control unit 13 controls the transmission rate setting unit 6 to set the transmission rate of transmission data from the communication interface 2, on the basis of the measurement result from the communication status measuring unit 3, the relation information stored in the communication quality database 5, and the information stored in the corresponding transmission rate storage unit 4.

The control unit 13 controls the communication status measuring unit 3 to measure the communication status with the counter party of communication every predetermined time interval during a transmission time when the status that transmission data can be transmitted and received between the IPTV phone and the counter party of communication is established, that is, during the session. The control unit 13 controls the transmission rate setting unit 6 to set the transmission rate of transmission data from the communication interface 2, on the basis of the measurement result from the communication status measuring unit 3, the relation information stored in the communication quality database 5, and the information stored in the corresponding transmission rate storage unit 4. The predetermined time is set in advance and is selected as, for example, several seconds.

In the transmission modes of the IPTV phone 1, the voice encoding method and the image encoding method are different from each other and thus the transmission rates of transmission data are different from each other. This is true of the transmission modes of the counter party of communication. Examples of the voice encoding method include “G.711 μ-law”, “G.711 A-law”, “G.729”, and “GSM.” The “G.711 μ-law”, “G.711 A-law” have a transmission rate of 64 kbps (kilo bit per second), the “G.729” has a transmission rate 4 kbps, and the “GSM” has a transmission rate of 6.4 kbps. Examples of the image encoding method include H264 and MPEG4 and the transmission rates are various. The transmission rate of images also depends upon an image size and a frame rate fps (frame per second).

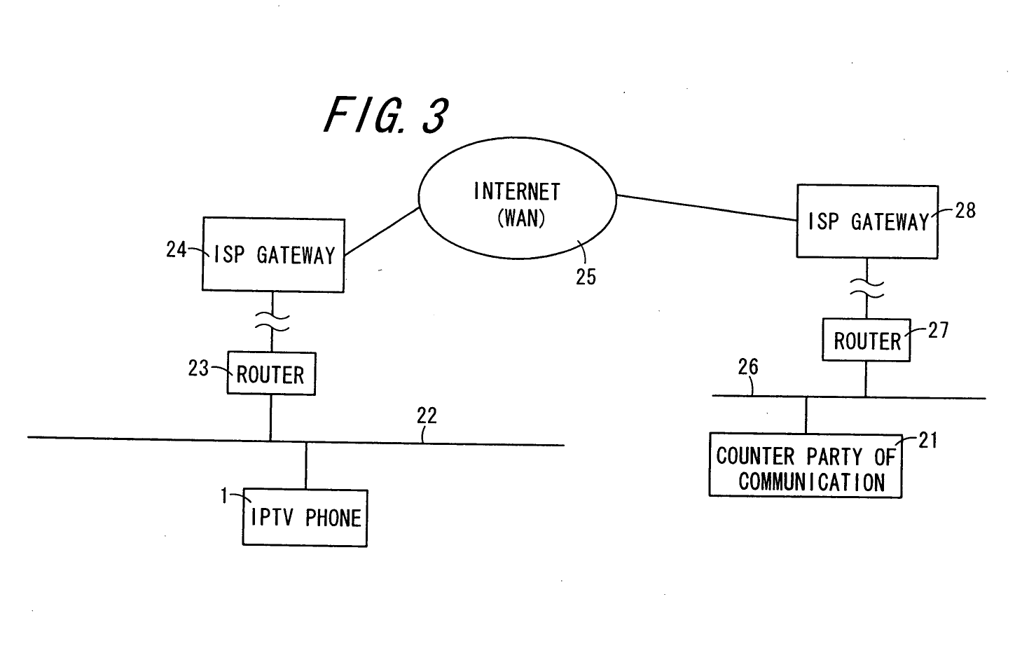

FIG. 3 is a diagram illustrating an example of a communication path between the IPTV phone 1 and the counter party of communication 21. The IPTV phone 1 is connected to a local area network (LAN) 22. The LAN 22 is connected to an ISP (Internet Service Provider) gateway 24 through a router 23. The ISP gateway 24 is connected to Internet 25. The counter party of communication 21 is connected to another LAN 26. The LAN 26 is connected to another ISP gateway 28 through another router 27. The ISP gateway 28 is connected to the Internet 25. In this way, the Internet 25 is interposed between the IPTV phone 1 and the counter party of communication 21.

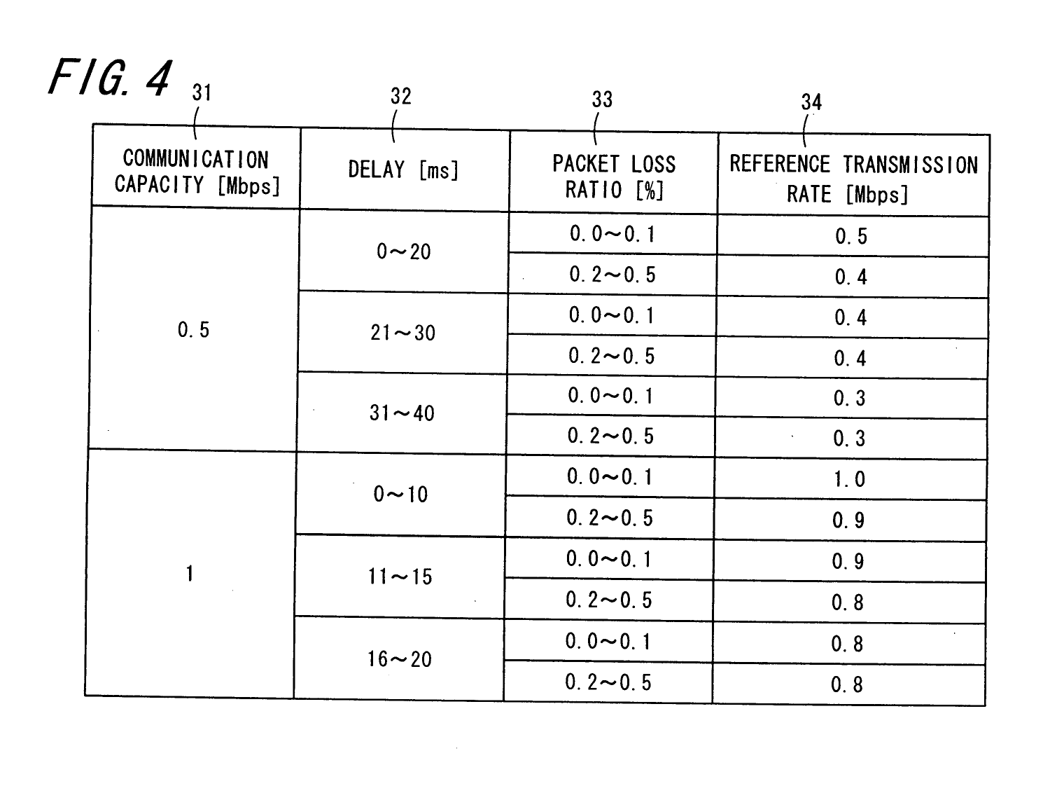

FIG. 4 is a diagram illustrating an example of relation information stored in advance in the communication quality database 5. The relation information indicates relations between a communication status and a reference transmission rate corresponding to the communication status. In the present embodiment, the communication status includes the communication capacity, the delay, and the packet loss ratio. In the relation information, information 31 on the communication capacity, information 32 on the delay, information 33 on the packet loss ratio, and information 34 on the reference transmission rate are related to correspond to each other. In the relation information, the reference transmission rate is less than or equal to the communication capacity, is low as the delay becomes greater, and is low as the packet loss ratio becomes greater.

For example, as shown in FIG. 4, when the communication capacity is 0.5 Mbps, the delay is less than or equal to 20 ms (millisecond), and the packet loss ratio is less than or equal to 0.1%, the reference transmission rate is 0.5 Mbps. When the communication capacity is 0.5 Mbps, the delay is greater than or equal to 21 ms and less than or equal to 30 ms, and the packet loss ratio is less than or equal to 0.1%, the reference transmission rate is 0.4 Mbps. When the communication capacity is 0.5 Mbps, the delay is less than or equal to 20 ms, and the packet loss ratio is less than or equal to 0.2% and less than or equal to 0.5%, the reference transmission rate is 0.4 Mbps.

In setting the transmission rate of transmission data from the communication interface 2, the transmission rate setting unit 6 obtains a reference transmission rate corresponding to the measurement result from the communication status measuring unit 3 with reference to the relation information stored in the communication quality database 5. The transmission rate setting unit 6 compares a plurality of transmission rates selectable by the IPTV phone with a plurality of transmission rates selectable by the counter party of communication 21 with reference to the information stored in the corresponding transmission rate storage unit 4 and obtains transmission rates common to the plurality of transmission rates selectable by the IPTV phone and the plurality of transmission rates selectable by the counter party of communication 21. The transmission rate setting unit 6 selects the maximum transmission rate less than the reference transmission rate corresponding to the measurement result as a transmission rate corresponding to the measurement result among the common transmission rates. The transmission rate setting unit 6 sets the transmission rate of transmission data from the communication interface 2 to the selected transmission rate.

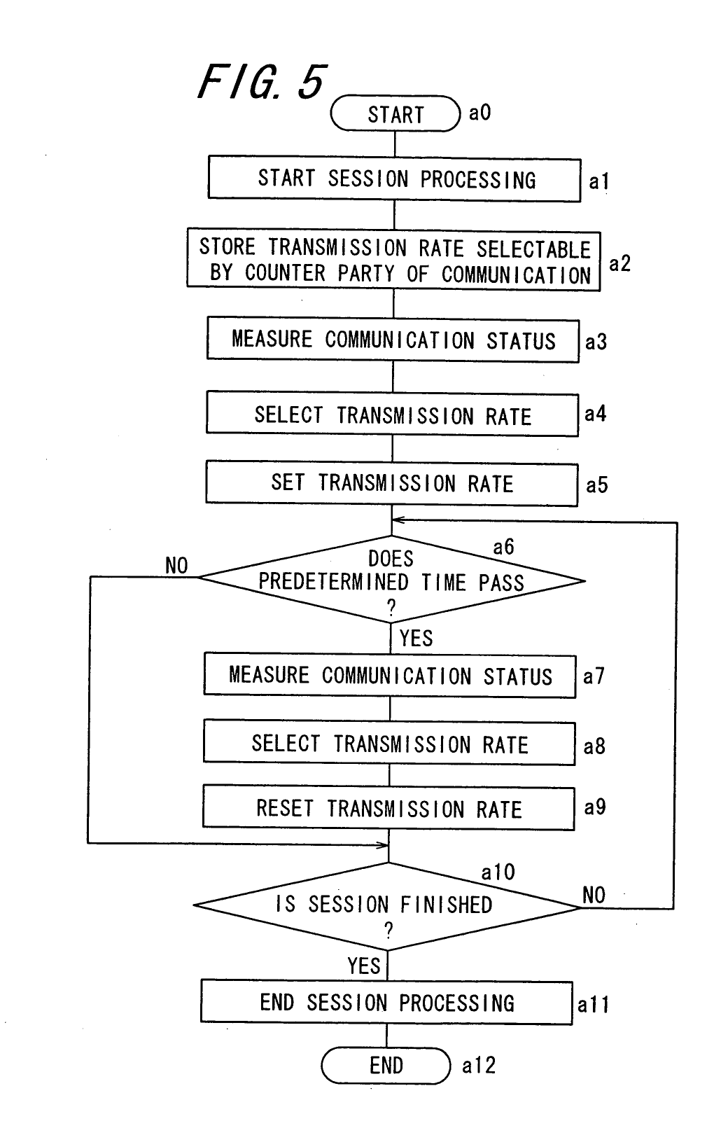

FIG. 5 is a flowchart illustrating a communication control operation performed by the control unit 13 of the IPTV phone 1. The communication control operation performed by the control unit 13 of the IPTV phone 1 is off-hooked by the operator's manipulation and is started when a phone number of the counter party of communication 21 is designated.

When the communication control operation is started, first, a session initiating process for establishing a session between the IPTV phone and the designated counter party of communication 21 is performed in step a1 and then step a2 is performed. In the session initiating process, information on an IP address of the counter party 21 of communication and information on a plurality of transmission rates selectable by the counter party of communication 21 are acquired. In step a2, information on the plurality of transmission rates selectable by the counter party of communication 21 is stored in the corresponding transmission rate storage unit 4 and then step a3 is performed.

In step a3, the communication status with the counter party of communication 21 is measured by the communication status measuring unit 3 and then step a4 is performed. In step a4, a transmission rate corresponding to the measurement result is selected by the transmission rate setting unit 6 on the basis of the measurement result from the communication status measuring unit 3, the relation information stored in the communication quality database 5, and the information stored in the corresponding transmission rate storage unit 4 and then step a5 is performed. In step a5, the transmission rate of transmission data from the communication interface 2 is set to the selected transmission rate by the transmission rate setting unit 6 and then step a6 is performed.

In step a6, it is determined whether a predetermined time has passed after the transmission rate of transmission data from the communication interface 2 is set. When it is determined that the predetermined time has not passed, step a10 is performed. When it is determined that the predetermined time has passed, step a7 is performed.

In step a7, the communication status with the counter party of communication 21 is measured by the communication status measuring unit 3 and then step a8 is performed. In step a8, the transmission rate corresponding to the measurement result is selected by the transmission rate setting unit 6 on the basis of the measurement result from the communication status measuring unit 3, the relation information stored in the communication quality database 5, and the information stored in the corresponding transmission rate storage unit 4 and then step a9 is performed. In step a9, the transmission rate of transmission data from the communication interface 2 is reset to the selected transmission rate by the transmission rate setting unit 6 and then step a10 is performed.

In step a10, it is determined whether the end of session is instructed. When it is determined that the end of session is not instructed, step a6 is performed again. When it is determined that the end of session is instructed, step all is performed. In step all, a session ending process for ending the session between the IPTV phone and the counter party of communication 21 is performed and the communication control operation is ended.

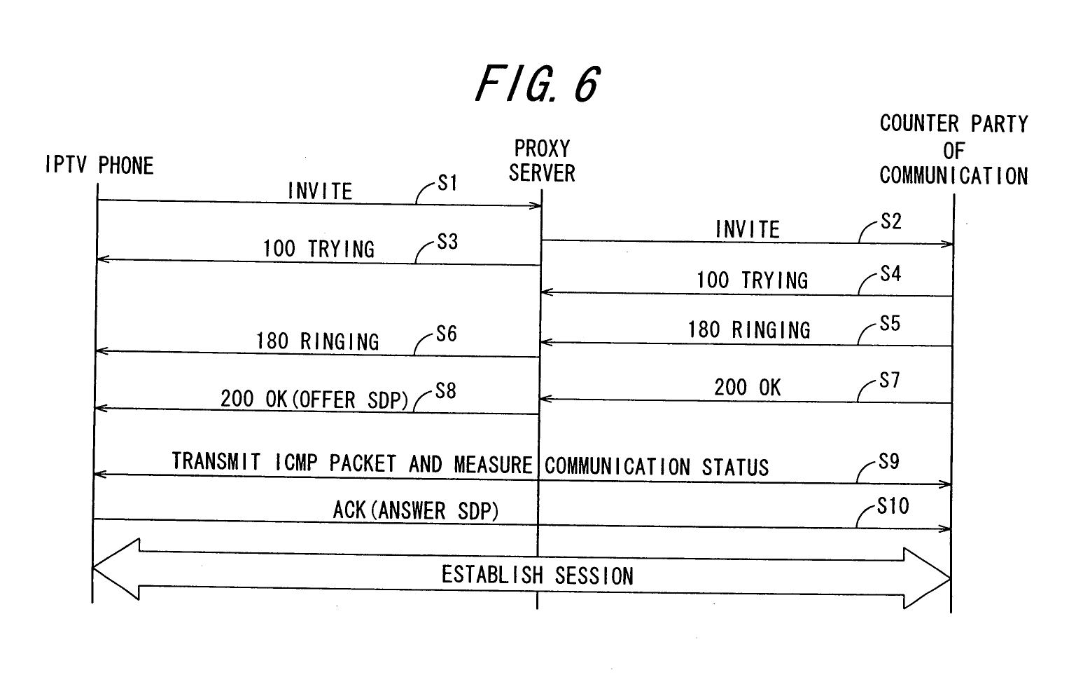

FIG. 6 is a sequence diagram illustrating a flow until a session is established between the IPTV phone 1 and the counter party of communication 21. When the IPTV phone 1 is off-hooked by the operator's manipulation and the phone number of the counter party of communication 21 is designated, first, the IPTV phone 1 transmits an INVITE method S1 as a request message to a proxy server.

When receiving the INVITE method S1 as the request message from the IPTV phone 1, the proxy server transmits an INVITE method S2 as a request message to the designated counter party of communication 21. The proxy server transmits a response message S3 of “Trying” in a status code “100” to the IPTV phone 1.

When receiving the INVITE method S2 as the request message from the proxy server, the counter party of communication 21 transmits a response message S4 of “Trying” in the status code “100” to the proxy server. The counter party of communication 21 starts a call report process for notifying “under call” and transmits a response message S5 of “Ringing” in a status code “180” to the proxy server.

When receiving the response message S5 of “Ringing” in the status code “180” from the counter party of communication 21, the proxy server transmits a response message S6 of “Ringing” in the status code “180” to the IPTV phone 1. When receiving the response message S6 of “Ringing” in the status code “180” from the proxy server, the IPTV phone 1 notifies “under call.” During the call notification process, the counter party of communication 21 is off-hooked and transmits a response message S7 of “OK” in a status code “200” to the proxy server. When receiving the response message S7 of “OK” in the status code “200” from the counter party of communication 21, the proxy server transmits a response message S8 of “OK” in the status code “200” to the IPTV phone 1.

The response message S8 includes information on the IP address of the counter party of communication 21 as header information. The response message includes information on a plurality of transmission rates selectable by the counter party of communication 21 as “Offer SDP (Session Description Protocol)” information. Accordingly, the IPTV phone 1 can acquire the information on the IP address of the counter party of communication 21 and the information on the plurality of transmission rates selectable by the counter party of communication 21, by receiving the response message S8 of “OK” in the status code “200” from the proxy server.

When receiving the response message S8 of “OK” in the status code “200” from the proxy server, the IPTV phone 1 stores the information on the plurality of transmission rates selectable by the counter party of communication 21 in the corresponding transmission rate storage unit 4. The IPTV phone 1 allows the communication state measuring unit 3 to measure the communication status with the counter party of communication 21 by the use of the information on the IP address of the counter party of communication 21. At this time, the IPTV phone 1 communicates with the counter party of communication 21, not through the proxy server.

Specifically, in measuring the communication status with the counter party of communication 21, the IPTV phone 1 transmits and receives an ICMP (Internet Control Message Protocol) message S9 by the use of a ping command.

In measuring the delay and the packet loss ratio, the IPTV phone 1 transmits a time stamp request as the ICMP message to the counter party of communication 21. When receiving the timestamp request as the ICMP message from the IPTV phone 1, the counter party of communication 21 transmits a timestamp reply as the ICMP message to the IPTV phone 1. The timestamp request and the timestamp reply are set in a TYPE filed of the ICMP message. The IPTV phone 1 obtains the delay and the packet loss ratio by the use of the received response message.

The delay is obtained by measuring the time until the timestamp reply is received after the timestamp request is received. The packet loss ratio is obtained by transmitting a predetermined number of packets, counting the number of received packets, and dividing the number obtained by subtracting the number of received packets from the number of transmitted packets by the number of transmitted packets.

In measuring the communication capacity, the IPTV phone 1 transmits a message designating a data size in the ICMP to the counter party of communication 21. When receiving the message designating the data size from the IPTV phone 1, the counter party of communication 21 transmits ACK to the IPTV phone 1. The communication capacity is obtained by measuring the time until ACK is received after the message designating the data size is transmitted and dividing the data size by the time.

The IPTV phone 1 allows the communication status measuring unit 3 to measure the communication status with the counter party of communication 21 and allows the transmission rate setting unit 6 to select a transmission rate corresponding to the measurement result on the basis of the measurement result from the communication status measuring unit 3, the relation information stored in the communication quality database 5, and the information stored in the corresponding transmission rate storage unit 4.

Thereafter, the IPTV phone 1 allows the transmission rate setting unit 6 to set the transmission rate of transmission data from the communication interface 2 to the selected transmission rate. At this time, the IPTV phone 1 transmits an ACK method S10 as a request message to the counter party of communication 21. The request message includes information on the selected transmission rate as “Answer SDP” information. When the counter party of communication 21 receives the ACK method as the request message from the IPTV phone 1, the session at the selected transmission rate is established.

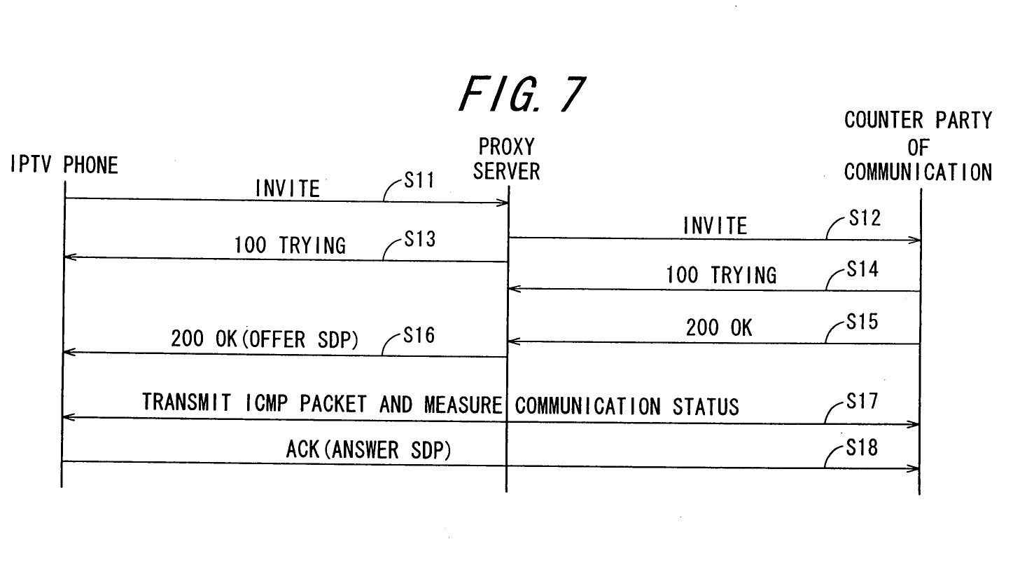

FIG. 7 is a sequence diagram illustrating a flow of resetting the transmission rate of transmission data during the session. When a predetermined time passes after the transmission rate of transmission data has been set, first, the IPTV phone 1 transmits an INVITE method S11 as a request message to the proxy server.

When receiving the INVITE method S11 as the request message from the IPTV phone 1, the proxy server transmits an INVITE method S12 as a request message to the designated counter party of communication 21. The proxy server transmits a response message S13 of “Trying” in a status code “100” to the IPTV phone 1.

When receiving the INVITE method S12 as a request message from the proxy server, the counter party of communication 21 transmits a response message S14 of “Trying” in the status code “100” to the proxy server. The counter party of communication 21 transmits a response message S15 of “OK” in a status code “200” to the proxy server.

When receiving the response message S15 of “OK” in the status code “200” from the counter party of communication 21, the proxy server transmits a response message S16 of “OK” in the status code “200” to the IPTV phone 1.

When receiving the response message S16 of “OK” in the status code “200” from the proxy server, the IPTV phone 1 allows the communication status measuring unit 3 to measure the communication status with the counter party of communication 21, similarly to the measurement of the communication status in FIG. 6.

The IPTV phone 1 allows the communication status measuring unit 3 to measure the communication status with the counter party of communication 21 and allows the transmission rate setting unit 6 to select a transmission rate corresponding to the measurement result on the basis of the measurement result from the communication status measuring unit 3, the relation information stored in the communication quality database 5, and the information stored in the corresponding transmission rate storage unit 4.

Thereafter, the IPTV phone 1 allows the transmission rate setting unit 6 to set the transmission rate of transmission data from the communication interface 2 to the selected transmission rate. At this time, the IPTV phone 1 transmits an ACK method S18 as a request message to the counter party of communication 21. The request message includes information on the selected transmission rate as “Answer SDP” information. When the counter party of communication 21 receives the ACK method as the request message from the IPTV phone 1, the transmission rate of transmission data is reset to the selected transmission rate.

According to the embodiment described above, the communication interface 2 transmits/receives the transmission data to/from the counter party of communication by the use of the Internet 25. The communication status measuring unit 3 measures the communication status with the counter party of communication 21. The transmission rate setting unit 6 sets the transmission rate of transmission data from the communication interface 2 to the transmission rate corresponding to the measurement result on the basis of the measurement result from the communication status measuring unit 3.

Since the transmission rate is set as described above, it is possible to transmit and receive transmission data at a transmission rate corresponding to the communication status with the counter party of communication 21 without giving an operator a burden necessary for setting the transmission rate. In the present embodiment, the transmission rate corresponding to the communication status with the counter party of communication 21 is a transmission rate having a small error and a transmission rate as great as possible.

When the communication status is not good, an error in communication can be reduced by transmitting and receiving transmission data at a low transmission rate corresponding to the communication status. When the communication status is good, the voice quality and the image quality can be enhanced by transmitting and receiving transmission data at a high transmission rate corresponding to the communication status.

In the present embodiment, it means the followings that the communication status is not good. That is, it means that the communication capacity is small, that the delay is great, and that the packet loss ratio is great. It means the followings that the communication status is good. That is, it means that the communication capacity is great, that the delay is small, and that the packet loss ratio is small.

In addition, since the communication status with the counter party of communication 21 is measured after the information on the IP address of the counter party of communication 21 is acquired, it is possible to measure the communication status with the counter party of communication 21 with respect to the same communication path as transmitting and receiving transmission data by the use of the information on the IP address of the counter party of communication 21. Therefore, the communication status with the counter party of communication 21 can be accurately measured.

Further, before the status that the transmission data can be transmitted and received between the IPTV phone and the counter party of communication 21 is established, as described above, the measurement of the communication status by the communication status measuring unit 3 and the setting of the transmission rate by the transmission rate setting unit 6 are performed. Therefore, from the time when the status that the transmission data can be transmitted and received between the IPTV phone and the counter party of communication 21 is established and the transmission and reception of the transmission data is started, it is possible to transmit and receive transmission data at the transmission rate corresponding to the communication status with the counter party of communication 21.

During the transmission time when the status that the transmission data can be transmitted and received between the IPTV phone and the counter party of communication 21 is established, as described above, the measurement of the communication status by the communication status measuring unit 3 and the setting of the transmission rate by the transmission rate setting unit 6 are performed. Therefore, during the transmission time, it is possible to change the transmission rate of transmission data to the transmission rate corresponding to the communication status with the counter party of communication 21.

Every predetermined time interval in the transmission time, as described above, the measurement of the communication status by the communication status measuring unit 3 and the setting of the transmission rate by the transmission rate setting unit 6 are performed. Therefore, even when the communication status with the counter party of communication 21 is often changed during the transmission time, it is possible to change the transmission rate of transmission data to the transmission rate corresponding to the communication status with the counter party of communication 21 every predetermined time interval.

For example, when the transmission rate of transmission data is set high and the communication status becomes worse, it is possible to prevent the increase in error in communication by lowering the transmission rate of transmission data in accordance with the change in communication status. In addition, when the transmission rate of transmission data is set low and the communication status becomes better, it is possible to enhance the voice quality and the image quality by enhancing the transmission rate of transmission data in accordance with the change in communication status.

The predetermined time interval is selected in several seconds. When the predetermined time is too smaller than the several seconds, for example, when the predetermined time has a unit of ms, a load to the control unit 13 is increased. In case of IP, the waiting time until a response message of “OK” in the status code “200” is received from the counter party of communication 21 after the INVITE method is transmitted as a request message to the counter party of communication 21 is 200 ms or more. Accordingly, it is preferable that the predetermined time is selected to be 400 ms or more. When the predetermined time is too greater than the several seconds, the time when the transmission rate of transmission data does not correspond to the communication status may be too elongated. When the predetermined time is several seconds, the load to the control unit 13 is small and the time when the transmission rate of transmission data does not correspond to the communication status can be shortened.

The communication status measuring unit 3 measures a second communication status relating to an error in communication, as well as a first communication status relating to the transmission rate of transmission data. Specifically, the communication status measuring unit 3 measures the delay and the packet loss ratio as the second communication status, as well as the communication capacity as the first communication status. Therefore, it is possible to accurately recognize the communication status. In addition, since the transmission rate of transmission data is set, it is possible to implement the transmission and reception of transmission data at a more suitable transmission rate.

The transmission rate setting unit 6 sets the transmission rate of transmission data from the communication interface 2 to the transmission rate corresponding to the measurement result on the basis of the measurement result from the communication status measuring unit 3 and the relation information stored in the communication quality database 5. When a relational expression between the communication status and the reference transmission rate corresponding to the communication status is used, the communication capacity can be classified as needed and different relational expressions can be used. Accordingly, a process of obtaining the transmission rate corresponding to the measurement result becomes complicated. On the contrary, since the above-described relation information is used in the present embodiment, it is possible to set the transmission rate more easily than the case that the relational expression.

The transmission rate setting unit 6 sets the transmission rate of transmission data from the communication interface 2 on the basis of a plurality of transmission rates selectable by the IPTV phone and a plurality of transmission rates selectable by the counter party of communication 21, as well as the measurement result from the communication status measuring unit 3. The transmission rate setting unit 6 sets the transmission rate of transmission data from the communication interface 2 to the transmission rate corresponding to the measurement result among the transmission rates common to the plurality of transmission rates selectable by the IPTV phone and the plurality of transmission rates selectable by the counter party of communication 21. Therefore, after a problem in compatibility of the transmission rate between the IPTV phone and the counter party of communication 21 has been solved, that is, in the state that the transmission rate is made equal between the IPTV phone and the counter party of communication, it is possible to transmit and receive transmission data.

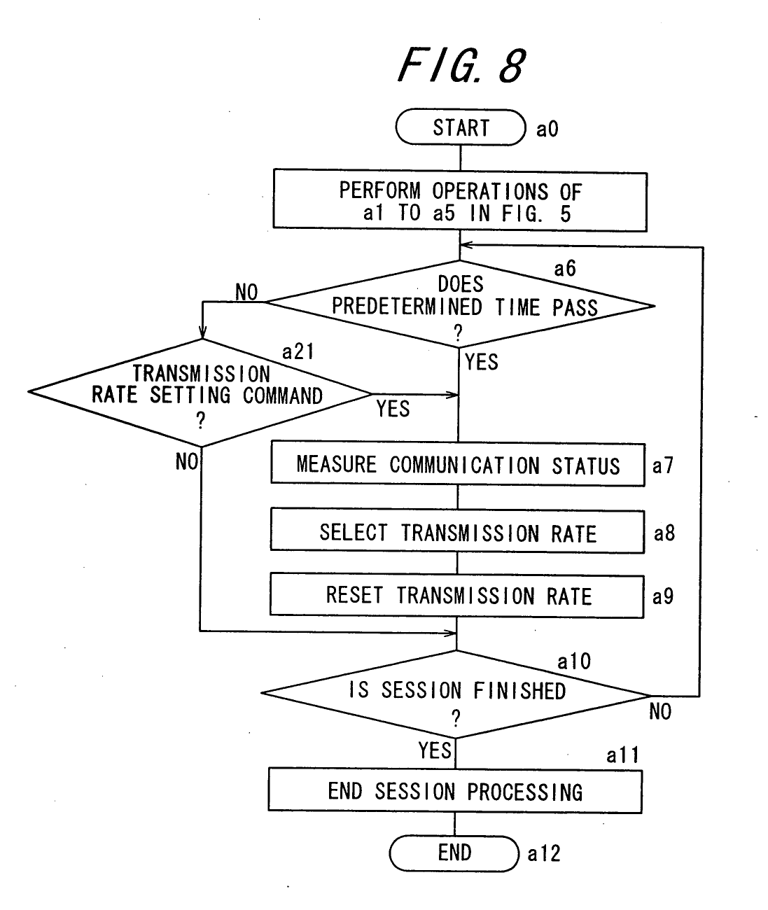

FIG. 8 is a flowchart illustrating a communication control operation of the control unit 13 included in an IPTV phone according to another embodiment of the invention. Since the IPTV phone according to the present embodiment is similar to the IPTV phone 1 according to the embodiment shown in FIGS. 1 to 7, the corresponding elements will be denoted by the same reference numerals and only different points will be described.

In the present embodiment, the manipulation unit 10 serves as input means for inputting a transmission rate setting command for instructing to set the transmission rate of transmission data. When the transmission rate setting command is inputted through the manipulation unit 10 during a session, the control unit 13 allows the communication status measuring unit 3 to measure the communication status with the counter party of communication 21. Then, the control unit 13 allows the transmission rate setting unit 6 to set a transmission rate of transmission data from the communication interface 2 on the basis of the measurement result from the communication status measuring unit 3, the relation information stored in the communication quality database 5, and the information stored in the corresponding transmission rate storage unit 4.

The communication control operation performed by the control unit 13 of the IPTV phone is off-hooked by the operator's manipulation and is started when a phone number of the counter party of communication 21 is designated. When the communication control operation is started, operations of steps a1 to a5 in FIG. 5 are performed and then step a6 is performed.

In step a6, it is determined whether a predetermined time passes after the transmission rate of transmission data from the communication interface 2 has been set. When it is determined that the predetermined time does not pass, step a21 is performed. When it is determined that the predetermined time passes, step a7 is performed.

In step a21, it is determined whether the transmission rate setting command is inputted. When it is determined that the transmission rate setting command is not inputted, step a10 is performed. When it is determined that the transmission rate setting command is inputted, step a7 is performed.

In step a7, the communication status with the counter party of communication 21 is measured by the communication status measuring unit 3 and then step a8 is performed. In step a8, the transmission rate corresponding to the measurement result is selected by the transmission rate setting unit 6 on the basis of the measurement result from the communication status measuring unit 3, the relation information stored in the communication quality database 5, and the information stored in the corresponding transmission rate storage unit 4, and then step a9 is performed. In step a9, the transmission rate of transmission data from the communication interface 2 is reset to the selected transmission rate by the transmission rate setting unit 6, and then step a10 is performed.

In step a10, it is determined whether an end of session is instructed. When it is determined that the end of session is not instructed, step a6 is performed again. When it is determined that the end of session is instructed, step all is performed. In step all, a session ending process for ending the session between the IPTV phone and the counter party of communication 21 is performed and the communication control operation is ended.

According to the present embodiment described above, when the transmission rate setting command is inputted through the manipulation unit 10 during the transmission time, as described above, the measurement of the communication status by the communication status measuring unit 3 and the setting of the transmission rate by the transmission rate setting unit 6 are performed. Therefore, since an operator can be instructed to measure the communication status and to set the transmission rate, the usability is improved.

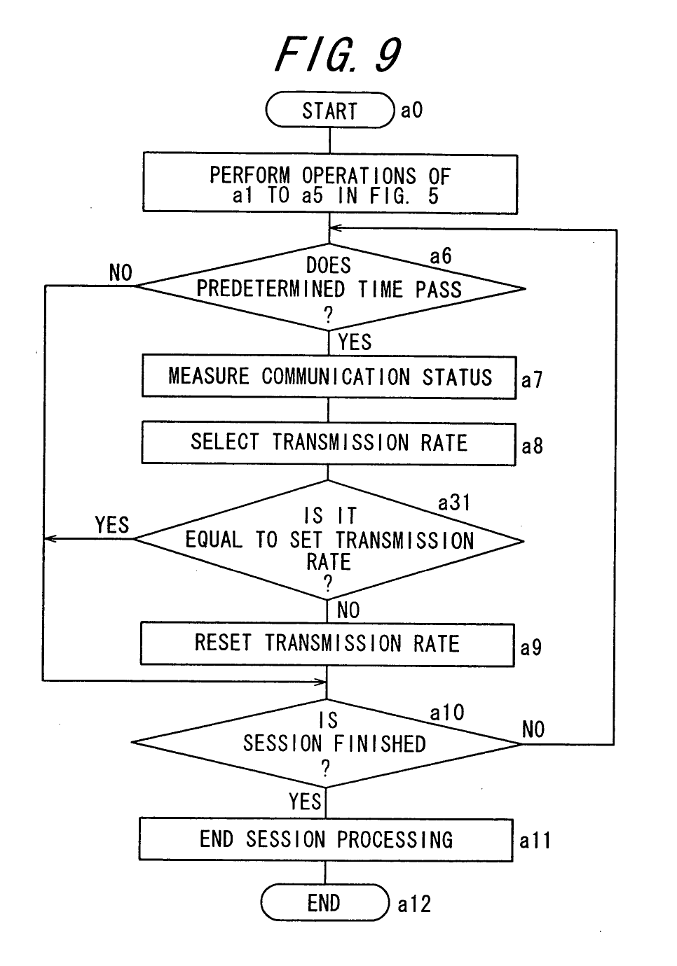

FIG. 9 is a flowchart illustrating a communication control operation of the control unit 13 included in an IPTV phone according to another embodiment of the invention. Since the IPTV phone according to the present embodiment is similar to the IPTV phone 1 according to the embodiment shown in FIGS. 1 to 7, the corresponding elements will be denoted by the same reference numerals and only different points will be described.

In the present embodiment, when the transmission rate of transmission data is previously set, the transmission rate setting unit 6 compares the transmission rate corresponding to the measurement result with the set transmission rate. When the transmission rates are equal to each other, the transmission rate setting unit 6 maintains the set transmission rate as the transmission rate of transmission data. When the transmission rates are different from each other, the transmission rate setting unit sets the transmission rate of transmission data to the transmission rate corresponding to the measurement result.

The communication control operation performed by the control unit 13 of the IPTV phone is off-hooked by the operator's manipulation and is started when a phone number of the counter party of communication 21 is designated. When the communication control operation is started, operations of steps a1 to a5 in FIG. 5 are performed and then step a6 is performed.

In step a6, it is determined whether a predetermined time passes after the transmission rate of transmission data from the communication interface 2 has been set. When it is determined that the predetermined time does not pass, step a10 is performed. When it is determined that the predetermined time passes, step a7 is performed.

In step a7, the communication status with the counter party of communication 21 is measured by the communication status measuring unit 3 and then step a8 is performed. In step a8, the transmission rate corresponding to the measurement result is selected by the transmission rate setting unit 6 on the basis of the measurement result from the communication status measuring unit 3, the relation information stored in the communication quality database 5, and the information stored in the corresponding transmission rate storage unit 4, and then step a31 is performed.

In step a31, the set transmission rate and the transmission rate corresponding to the measurement result are compared with each other and it is determined whether the transmission rates are equal to each other, by the transmission rate setting unit 6. When it is determined that the transmission rates are equal to each other, step a10 is performed. When it is determined that the transmission rates are different from each other, step a9 is performed. In step a9, the transmission rate of transmission data from the communication interface 2 is reset to the selected transmission rate by the transmission rate setting unit 6, and then step a10 is performed.

In step a10, it is determined whether an end of session is instructed. When it is determined that the end of session is not instructed, step a6 is performed again. When it is determined that the end of session is instructed, step all is performed. In step all, a session ending process for ending the session between the IPTV phone and the counter party of communication 21 is performed and the communication control operation is ended.

According to the present embodiment described above, when the transmission rate of transmission data from the communication interface 2 is previously set, the set transmission rate and the transmission rate corresponding to the measurement result are compared with each other. When the transmission rates are different from each other, the transmission rate of transmission data from the communication interface is set to the transmission rate corresponding to the measurement result, but when the transmission rates are equal to each other, the set transmission rate is maintained. Therefore, it is possible to reduce the amount of processing necessary for setting the transmission rate. In addition, it is possible to reduce a burden imposed on the proxy server.

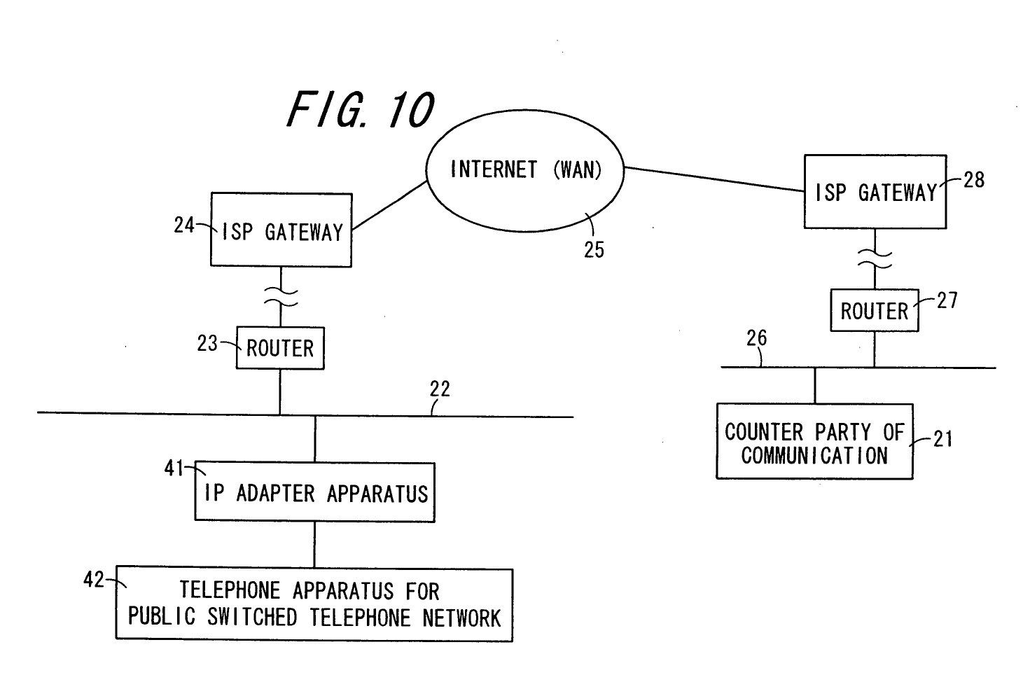

FIG. 10 is a diagram illustrating an example of a communication path between an IP adapter apparatus 41 and a counter party of communication 21 according to another embodiment of the invention. The IP adapter apparatus 41 is connected to a telephone apparatus 42 for a public switched telephone network. The IP adapter apparatus 41 is connected to a LAN 22. The LAN 22 is connected to an ISP gateway 24 through a router 23. The ISP gateway 24 is connected to Internet 25. In this way, the IP adapter apparatus 41 is interposed between the telephone apparatus 42 for a public switched telephone network and the Internet 25.

The IP adapter apparatus 41 according to the present embodiment has the same configuration as the IPTV phone 1 according to the above-mentioned embodiments, except that the hand set 7, the image pickup unit 8, and the display unit 9 are omitted. The IP adapter apparatus 41 supplies the transmission data from the counter party of communication 21 to the telephone apparatus 42 for a public switched telephone network and transmits voice data and image data from the telephone apparatus 42 for a public switched telephone network as the transmission data to the counter party of communication 21.

According to the present embodiment, even when the telephone apparatus 42 for a public switched telephone network is used, the same advantages as the above-mentioned embodiments can be obtained.

The embodiments described above are merely examples of the invention and configurations can be changed within the scope of the invention. For example, the communication status measuring unit 3 may further measure a jitter and a reversion of an arrival order of packets as the communication status. The jitter is a difference between the arrival intervals of packets. The jitter and the reversion of the arrival order of packets correspond to the second communication status relating to the error in communication. The transmission rate setting unit 6 may set the transmission rate of transmission data from the communication interface 2 on the basis of the jitter and the reversion of the arrival order of packets, as well as the communication capacity, the delay, and the packet loss ratio.

In the above-mentioned embodiments, the transmission rate setting unit 6 selects the maximum transmission rate less than or equal to the reference transmission rate corresponding to the measurement result among the transmission rates common to a plurality of transmission rates selectable by the IPTV phone or the IP adapter apparatus and a plurality of transmission rates selectable by the counter party of communication 21 as the transmission rate corresponding to the measurement result, but the transmission rate closest to the reference transmission rate corresponding to the measurement result among the common transmission rates may be selected as the transmission rate corresponding to the measurement result.

The communication status measuring unit 3 may measure at least one of the communication capacity, the delay, the packet loss ratio, the jitter, and the reversion of the arrival order of packets as the communication status. For example, when the communication status measuring unit 3 measures only the communication capacity as the communication status, the transmission rate setting unit 6 may select the maximum transmission rate less than or equal to the communication capacity among the common transmission rates as the transmission rate corresponding to the measuring result.

In the embodiments described above, the transmission rate setting unit 6 acquires the reference transmission rate corresponding to the measurement result from the communication status measuring unit 3 with reference to the relation information stored in the communication quality database 5, but may acquire the reference transmission rate corresponding to the measurement result from the communication status measuring unit 3 by the use of a relational expression between the communication status and the reference transmission rate corresponding to the communication status.

The communication status with the counter party of communication 21 may be measured by the use of FTP (File Transfer Protocol). In this case, the communication status with the counter party of communication 21 can be accurately measured. In addition, the communication status with the counter party of communication 21 may be measured by the use of UDP (User Datagram Protocol). In this case, the communication status with the counter party of communication 21 can be also accurately measured.

The predetermined time which is a time interval at which the communication status with the counter party of communication 21 may be not constant and may be changed by the operator's manipulation of the manipulation unit 10. In this case, by considering that the burden imposed on the control unit 13 as the predetermined time is shortened, the predetermined time may not be set to be smaller than a previously determined time, for example, 400 ms.

The predetermined time may be set in accordance with the measurement result from the communication status measuring unit 3. When the communication status is good, the time until the communication status becomes worse is relatively long as the change of the transmission rate is necessary. By setting the predetermined time greater in consideration of this fact, it is possible to reduce the amount of processing necessary for measuring the communication status and setting the transmission rate. When the communication status is not good, the time until the communication status becomes worse is relatively short as the change of the transmission rate is necessary. By setting the predetermined time small in consideration of this fact, it is possible to reduce the time when the transmission rate of transmission data does not correspond to the communication status.

For example, when the communication capacity is great and a session at 5 Mbps is established, the predetermined time is set to a time interval which is several times a predetermined reference interval. On the contrary, when the communication capacity is small and a session at 0.5 Mbps is initiated, the predetermined time is set to a time interval which is a part of the predetermined reference interval. Since the maximum transmission rate in an existing IPTV phone 1 is 2 Mbps, 2 Mbps is used as a reference for determining whether the communication capacity is great. A default transmission rate may be used as a reference instead of the maximum transmission rate.

In the above-mentioned embodiments, the transmission rate of transmission data is reset by the use of the INVITE method, but the transmission rate of transmission data may be reset by the use of an UPDATE method instead of the INVITE method.

The measurement of the communication status by the communication status measuring unit 3 and the setting of the transmission rate by the transmission rate setting unit 6 may not be necessarily performed both of before the status that the transmission data can be transmitted and received between the IPTV phone or the IP adapter apparatus and the counter party of communication 21 is established and during the transmission time when the status that transmission data can be transmitted and received between the IPTV phone or the IP adapter apparatus and the counter party of communication 21 is established, but may be performed at any one time.

The control unit 13 may allow an image indicating the set transmission rate to be displayed on the display unit 9. In this case, an operator can be allowed to recognize the set transmission rate.

The invention may be applied to an IP phone. In case of SIP, the IPTV phone transmits and receives voice data and image data in RTP, but the IP phone transmits and receives only voice data in RTP. In such an IP phone, the same advantages as those of the embodiments described above can be obtained.

The invention can be applied to any if only it is a communication apparatus executing a streaming operation, not limited to the IP telephone apparatus and the IP adapter apparatus. The invention can be used when data stored in files is delivered by the use of a delivery server executing the streaming operation or when image data acquired by a video camera or the like is delivered in real time.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An IP telephone apparatus for transmitting/receiving at least one of voice data and image data to/from a counter party of communication by the use of Internet, the IP telephone apparatus comprising:
communication means for transmitting and receiving transmission data;
communication status measuring means for measuring a communication status with the counter party of communication; and
transmission rate setting means for setting a transmission rate of transmission data from the communication means to a transmission rate corresponding to the measurement result on the basis of the measurement result from the communication status measuring means.

2. The IP telephone apparatus of claim 1, wherein before a status that transmission data can be transmitted to and received from the counter party of communication is established, the communication status measuring means measures the communication status with the counter party of communication and the transmission rate setting means sets the transmission rate of transmission data from the communication means to a transmission rate corresponding to the measurement result on the basis of the measurement result from the communication status measuring means.

3. The IP telephone apparatus of claim 1, wherein during a transmission time when the status that transmission data can be transmitted to and received from the counter party of communication is established, the communication status measuring means measures the communication status with the counter party of communication and the transmission rate setting means sets the transmission rate of transmission data from the communication means to a transmission rate corresponding to the measurement result on the basis of the measurement result from the communication status measuring means.

4. The IP telephone apparatus of claim 3, wherein every predetermined time interval in the transmission time, the communication status measuring means measures the communication status with the counter party of communication and the transmission rate setting means sets the transmission rate of transmission data from the communication means to a transmission rate corresponding to the measurement result on the basis of the measurement result from the communication status measuring means.

5. The IP telephone apparatus of claim 4, wherein the predetermined time is set in accordance with the measurement result from the communication status measuring means.

6. The IP telephone apparatus of claim 3, further comprising input means for inputting a transmission rate setting command instructing to set the transmission rate of transmission data,
wherein when the transmission rate setting command is inputted by the input means during the transmission and reception, the communication status measuring means measures the communication status with the counter party of communication and the transmission rate setting means sets the transmission rate of transmission data from the communication means to a transmission rate corresponding to the measurement result on the basis of the measurement result from the communication status measuring means.

7. The IP telephone apparatus of claim 3, wherein when the transmission rate of transmission data from the communication means is set in advance, the transmission rate setting means compares the set transmission rate with the transmission rate corresponding to the measurement result, maintains the transmission rate of transmission data from the communication means at the set transmission rate when the transmission rates are equal to each other, and sets the transmission rate of transmission data from the communication means to the transmission rate corresponding to the measurement result when the transmission rates are different from each other.

8. The IP telephone apparatus of claim 1, wherein the communication status measuring means measures at least one of a communication capacity, a time delay, a packet loss ratio, and a jitter as the communication status.

9. The IP telephone apparatus of claim 1, further comprising a database in which relation information indicating a relation between the communication status and a reference transmission rate corresponding to the communication status is stored in advance, and
wherein the transmission rate setting means sets the transmission rate of transmission data from the communication means to the transmission rate corresponding to the measurement result on the basis of the measurement result from the communication status measuring means and the relation information recorded in the database.

10. The IP telephone apparatus of claim 1, wherein on the basis of a plurality of transmission rates selectable by the IP telephone apparatus, a plurality of transmission rates selectable by the counter party of communication, and the measurement result from the communication status measuring means, the transmission rate setting means sets the transmission rate of transmission data from the communication means to the transmission rate corresponding to the measurement result among the transmission rates common to the plurality of transmission rates selectable by the IP telephone apparatus and the plurality of transmission rates selectable by the counter party of communication.

11. An IP adapter apparatus which is interposed between a telephone apparatus for a public switched telephone network and Internet and which transmits/receives at least one of voice data and image data to/from a counter party of communication by the use of Internet in a status that a transmission rate is made to be equal to that of the counter party of communication, the IP adapter apparatus comprising:
communication means for transmitting and receiving transmission data;
communication status measuring means for measuring a communication status with the counter party of communication; and
transmission rate setting means for setting a transmission rate of transmission data from the communication means to a transmission rate corresponding to the measurement result on the basis of the measurement result from the communication status measuring means.
